(19) United States
(12) Patent Application Publication
(10) Pub. No.: US 2004/0054593 A1
(43) Pub. Date: Mar. 18, 2004

(54) Method and apparatus for facilitating the play of fractional lottery tickets utilizing point-of -sale terminals

(76) Inventor: Andrew S. Van Luchen, Norwalk, CT (US)

Correspondence Address: WALKER DIGITAL, FIVE HIGH RIDGE PARK, STAMFORD, CT, 06905, US

(21) Appl. No.: 10/643,803

(22) Filed: Aug. 19, 2003

Related U.S. Application Data
(63) Continuation of application No. 09/107,971, filed on Jun. 30, 1998.
Application No. 09/107,971 is a continuation-in-part of application No. 09/045,036, filed on Mar. 20, 1998.
Application No. 09/107,971 is a continuation-in-part of application No. 08/920,116, filed on Aug. 26, 1997, now Pat. No. 6,119,099.
Application No. 08/920,116 is a continuation-in-part of application No. 08/822,709, filed on Mar. 21, 1997, now Pat. No. 6,267,670.

(51) Int. Cl. G06F 17/60

(52) U.S. Cl. 705/16

(57) ABSTRACT

In accordance with the present invention, a store controller determines a monetary value, such as an amount of spare change due to a customer. The store controller also selects a ticket record that includes a set of ticket numbers. Subsequently, the store controller purchases at least one lottery ticket based on the monetary value and the set of ticket numbers. The store controller then outputs the information to a POS terminal, which prints a fractional lottery ticket redeemable for a portion of the lottery ticket's prize. The fractional lottery ticket includes the ticket numbers and a fractional lottery ticket value that is based on the monetary value. The fractional lottery ticket value may be, for example, equal to the monetary value, or may be the monetary value rounded to the nearest nickel. After a drawing date for the lottery ticket, the customer redeems the fractional lottery ticket, typically at a POS terminal, if a prize is due. The POS terminal communicates with the store controller, which receives the ticket numbers and the fractional lottery ticket value therefrom. From the received information, the store controller may determine a prize value of the corresponding lottery ticket. The customer is, in turn, provided with a portion of the prize value based on the fractional lottery ticket value.

### CROSS-REFERENCE TO RELATED APPLICATIONS

The present application is a continuation-in-part application of co-pending patent application Ser. No. 09/045,036, entitled METHOD AND APPARATUS FOR FACILITATING THE PLAY OF FRACTIONAL LOTTERY TICKETS UTILIZING POINT-OF-SALE TERMINALS, filed on Mar. 20, 1998, and a continuation-in-part application of co-pending patent application Ser. No. 08/920,116, entitled METHOD AND SYSTEM FOR PROCESSING SUPPLEMENTARY PRODUCT SALES AT A POINT-OF-SALE TERMINAL, filed on Aug. 26, 1997, which is a continuation-in-part of co-pending patent application Ser. No. 08/822,709, entitled SYSTEM AND METHOD FOR PERFORMING LOTTERY TICKET TRANSACTIONS UTILIZING POINT-OF-SALE TERMINALS, filed on Mar. 21, 1997, each of which are incorporated herein by reference.

### CROSS REFERENCE TO CO-PENDING APPLICATIONS

The present invention is related to the following United States patent applications:

U.S. patent application Ser. No. 09/045,084, entitled METHOD AND APPARATUS FOR CONTROLLING OFFERS THAT ARE PROVIDED AT A POINT OF SALE TERMINAL, filed on Mar. 20, 1998; U.S. patent application Ser. No. 09/045,518, entitled METHOD AND APPARATUS FOR PROCESSING A SUPPLEMENTARY PRODUCT AT A POINT OF SALE TERMINAL, filed Mar. 20, 1998; U.S. patent application Ser. No. 09/045,386, entitled METHOD AND APPARATUS FOR CONTROLLING THE PERFORMANCE OF A SUPPLEMENTARY PROCESS AT A POINT OF SALE TERMINAL, filed Mar. 20, 1998; U.S. patent application Ser. No. 09/045,347, entitled METHOD AND APPARATUS FOR PROCESSING A SUPPLEMENTARY PRODUCT SALE AT A POINT OF SALE TERMINAL, filed Mar. 20, 1998; and U.S. patent application Ser. No. 09/083,689, entitled METHOD AND SYSTEM FOR SELLING SUPPLEMENTAL PRODUCTS AT A POINT OF SALE TERMINAL, filed May 21, 1998, each assigned to the assignee of the present invention and incorporated by reference herein.

### FIELD OF THE INVENTION

The present invention relates to point-of-sale terminals, and more specifically to point-of-sale terminals that facilitate the purchase of lottery tickets.

### BACKGROUND OF THE INVENTION

Lotteries are extremely popular games that generate significant revenues for sponsoring states that offer them. In a typical lottery, a player (ticket holder) purchases a lottery ticket having ticket numbers and a serial number inscribed thereon. The ticket numbers allow both the ticket holder and a lottery agent to identify whether the ticket holder has won a prize. The serial number uniquely identifies the lottery ticket, and is typically recorded by a lottery agency so that the lottery ticket may be validated. For example, the serial number may be used to verify whether the ticket numbers inscribed on a ticket match those ticket numbers that the lottery agency has recorded as associated with that lottery ticket.

A typical lottery ticket has six ticket numbers, each selected from a range, such as the range from one to forty-nine. The six ticket numbers may have been selected by the ticket holder or, at the request of the ticket holder, randomly selected by the lottery terminal printing the ticket. On a drawing date, the lottery agency randomly selects six ticket numbers, which are deemed “winning” ticket numbers. A lottery ticket having ticket numbers that match some or all of the winning ticket numbers is a winning ticket, and the corresponding holder of the lottery ticket wins a prize.

The grandparent application of the present application, patent application Ser. No. 08/822,709, entitled SYSTEM AND METHOD FOR PERFORMING LOTTERY TICKET TRANSACTIONS UTILIZING POINT-OF-SALE TERMINALS, filed on Mar. 21, 1997, discloses a system and method by which fractional lottery tickets may be sold to a customer at a point-of-sale (“POS”) terminal in exchange for change due. For example, a customer may bring a purchase to a POS terminal, and the POS terminal may calculate the purchase price to be $4.74. If the purchase price is rounded to the nearest $1, the change due is $5.00-$4.74=$0.26. Accordingly, the customer may be sold a 26% share of a $1 lottery ticket in lieu of the change due. If the lottery ticket wins, 26% of the corresponding prize is awarded to the customer.

There are numerous advantages to providing a fractional lottery ticket in exchange for change due. As described in the parent application of the present application, patent application Ser. No. 08/920,116, entitled METHOD AND SYSTEM FOR PROCESSING SUPPLEMENTARY PRODUCT SALES AT A POINT-OF-SALE TERMINAL, filed on Aug. 26, 1997, dispensing and collecting coins is costly and burdensome. Furthermore, many customers consider coins to be dirty, and would prefer not to handle them. Thus, many customers will find the exchange of change due for a fractional lottery ticket to be very desirable.

Unfortunately, some state lottery agencies may be reluctant to change their practices by issuing lottery tickets for fractional amounts. Such state lottery agencies may instead prefer to offer tickets in only a few predetermined, rounded amounts, such as tickets for $1, $2 and $5 only. In some circumstances, the ability to offer fractional lottery tickets may require substantial modifications to the hardware and software of lottery terminals used throughout one or more states. Although such changes may ultimately be profitable, the initial cost may be perceived to be unduly burdensome, and the eventual profit to be made may appear too speculative. In summary, the issuance of fractional lottery tickets by state lottery agencies may not be practical in all circumstances.

Accordingly, it would be advantageous to facilitate the purchase of fractional lottery tickets without requiring significant changes in existing lottery systems.

### SUMMARY OF THE INVENTION

It is an object of the present invention to facilitate the purchase of fractional lottery tickets without requiring significant changes to existing lottery systems.

In accordance with the present invention, a store controller determines a monetary value, such as an amount of spare change due to a customer. The store controller also selects a ticket record that includes a set of ticket numbers. Subsequently, the store controller purchases at least one lottery ticket based on the monetary value and the set of ticket numbers. The store controller then outputs the information to a POS terminal, which prints a fractional lottery ticket redeemable for a portion of the lottery ticket's prize. The fractional lottery ticket includes the ticket numbers and a fractional lottery ticket value that is based on the monetary value. The fractional lottery ticket value may be, for example, equal to the monetary value, or may be the monetary value rounded to the nearest nickel.

After a drawing date for the lottery ticket, the customer redeems the fractional lottery ticket, typically at a POS terminal, if a prize is due. The POS terminal communicates with the store controller, which receives the ticket numbers and the fractional lottery ticket value therefrom. From the received information, the store controller may determine a prize value of the corresponding lottery ticket. The customer is, in turn, provided with a portion of the prize value based on the fractional lottery ticket value.

### BRIEF DESCRIPTION OF THE DRAWINGS

FIG. 1 is a schematic illustration of a network of POS terminals provided in accordance with the present invention.

FIG. 2 is a schematic illustration of a store controller of the network of FIG. 1.

FIG. 3 is a schematic illustration of a POS terminal of the network of FIG. 1.

FIG. 4 is a schematic illustration of an alternate embodiment of a POS terminal of the network of FIG. 1.

FIG. 5 is a schematic illustration of a ticket record database of the store controller of FIG. 2.

FIG. 6 is a schematic illustration including exemplary data for the ticket record database of FIG. 5.

FIG. 7 is a schematic illustration of a transaction database of the store controller of FIG. 2.

FIG. 8 is a schematic illustration of records of a fractional ticket database of the store controller of FIG. 2.

FIG. 9 is a schematic illustration including further exemplary data for the ticket record database of FIG. 5.

FIG. 10 is a flow chart illustrating a method for creating fractional lottery tickets.

FIG. 11 is a schematic illustration of a ticket supply database of the store controller of FIG. 2.

FIG. 12 is a schematic illustration of a winning lottery ticket database of the store controller of FIG. 2.

FIG. 13 is a schematic illustration of a frequent shopper database of the store controller of FIG. 2.

FIG. 14 is a flow chart illustrating a method for redeeming a fractional lottery ticket.

### DETAILED DESCRIPTION OF THE PREFERRED EMBODIMENTS

In accordance with the present invention, a business may issue a fractional lottery ticket to a customer, and subsequently acquire at least one lottery ticket having the same ticket numbers as the fractional lottery ticket. The fractional lottery ticket has a “value” that defines a portion of the lottery ticket. A share of any prize that is won with the lottery ticket is provided to the customer, the share of the prize being based on the portion. The value of the fractional lottery ticket may be expressed as a monetary value, such $0.34, and/or as a percentage, such as 17%. For example, if a customer receives a fractional lottery ticket having a value of $0.34 and defining a portion of a $2.00 lottery ticket, then the customer receives 17% ($0.34/$2.00=17%) of any prize won with that lottery ticket.

Typically, the business will provide fractional lottery tickets to customers and then acquire a group of corresponding lottery tickets before the drawing date. The prizes won by the group of lottery tickets are received by the business, which in turn pays shares of the prizes to customers based on the portions defined by the values of the fractional lottery tickets. Since the business need only purchase conventional lottery tickets, the business may facilitate the play of fractional lottery tickets without requiring significant changes in existing lottery agency practices.

A portion defined by a fractional lottery ticket may be based on a change amount that is due in connection with a transaction at a POS terminal. Such an embodiment is advantageous since many customers will welcome an alternative to receiving change. Moreover, receiving something having a high perceived value, such as a fractional lottery ticket, instead of change can be even more attractive to customers.

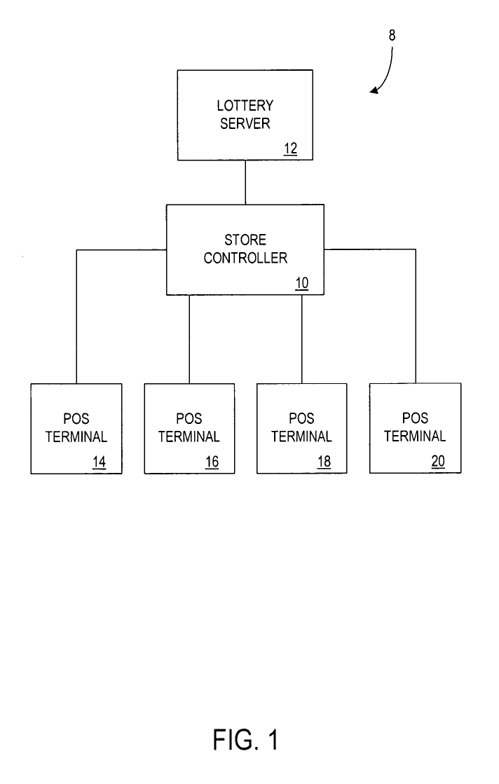

Referring to FIG. 1, a network 8 comprises a store controller 10, which is in communication with a lottery server 12 and with POS terminals 14, 16, 18 and 20. The POS terminals 14, 16, 18 and 20, which are typically cash registers, may initiate and/or complete fractional lottery ticket transactions. Although four POS terminals are shown in FIG. 1, any number of POS terminals may be in communication with the store controller 10. The POS terminals 14, 16, 18 and 20 may be located in the same store, in different stores of a chain of stores, or in other locations.

The store controller 10 directs the operation of, stores data from and transmits data to the POS terminals 14, 16, 18 and 20. The store controller 10 may itself be a POS terminal or may be another computing device that can communicate with one or more POS terminals. The lottery server 12 is typically controlled by a state lottery agency, and responds to requests from the store controller 10. For example, the lottery server 12 may issue lottery tickets as requested by the store controller 10, and may provide the winning numbers for a drawing date.

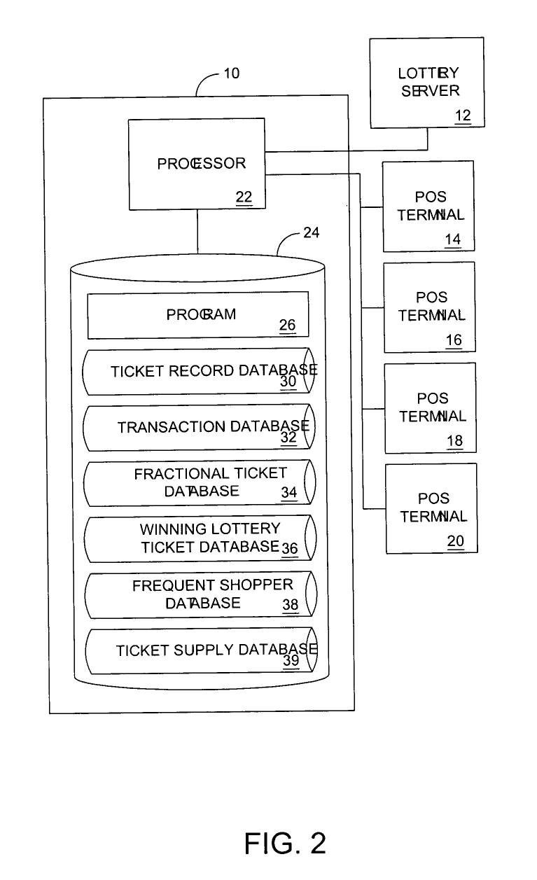

Referring to FIG. 2, the store controller 10 of FIG. 1 comprises a processor 22, such as one or more conventional microprocessors. The processor 22 is in communication with a data storage device 24, such as an appropriate combination of magnetic, optical and/or semiconductor memory. The processor 22 and the storage device 24 may each be (i) located entirely within a single computer or other computing device; (ii) in communication with each other by a remote communication link, such as a serial port cable, telephone line or radio frequency transceiver; or (iii) a combination thereof. For example, the store controller 10 may comprise one or more computers that are in communication with a remote server computer for maintaining databases.

The storage device 24 stores a program 26 for controlling the processor 22. The processor 22 performs instructions of the program 26, and thereby operates in accordance with the present invention, and particularly in accordance with the methods described in detail herein. The program 26 furthermore includes program elements that may be necessary, such as an operating system and “device drivers” for allowing the processor 22 to interface with computer peripheral devices. Appropriate device drivers and other necessary program elements are known to those skilled in the art, and thus need not be described in detail herein.

The storage device 24 also stores (i) ticket record database 30; (ii) a transaction database 32; (iii) a fractional ticket database 34; (iv) a winning lottery ticket database 36; (v) a frequent shopper database 38; and (vi) a ticket supply database 39. The databases 30, 32, 34, 36, 38 and 39 are described in detail below and depicted with exemplary entries in the accompanying figures. As will be understood by those skilled in the art, the schematic illustrations of and accompanying descriptions of the databases presented herein are exemplary arrangements for stored representations of information. A number of other arrangements may be employed besides the tables shown. Similarly, the illustrated entries represent exemplary information, but those skilled in the art will understand that the number and content of the entries can be different from those illustrated herein.

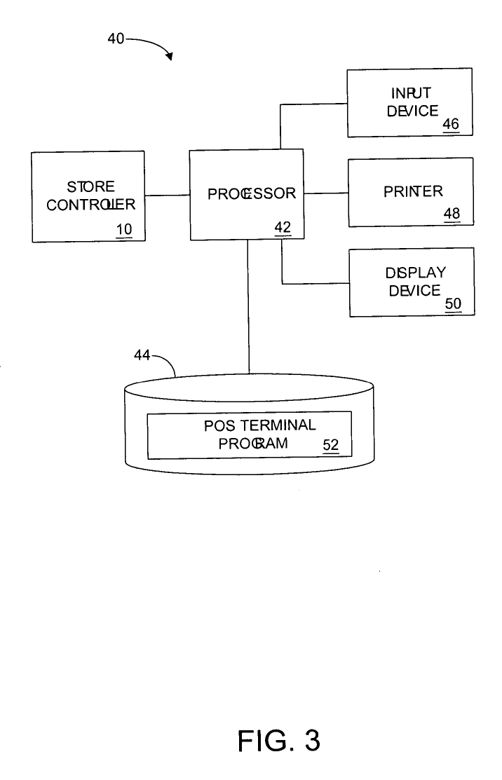

Referring to FIG. 3, a schematic illustration of a POS terminal 40 is descriptive of the POS terminals 14, 16, 18 and 20 of FIG. 1. The POS terminal 40 comprises a processor 42, such as one or more conventional microprocessors. The processor 42 is in communication with a data storage device 44, such as an appropriate combination of magnetic, optical and/or semiconductor memory. The processor 42 and the storage device 44 may each be (i) located entirely within a single computer or other computing device; (ii) in communication with each other by a remote communication link, such as a serial port cable, telephone line or radio frequency transceiver; or (iii) a combination thereof. For example, the POS terminal 40 may comprise one or more computers which are in communication with a remote server computer for maintaining databases.

An input device 46, a printer 48 and a display device 50 are each in communication with the processor 42. The input device 46 preferably comprises a keypad for transmitting input signals, such as signals indicative of a purchase, to the processor 42. The input device 46 may also comprise an optical bar code scanner for reading bar codes and transmitting signals indicative of those bar codes to the processor 42. The printer 48 is for registering indicia on paper or other material, thereby printing fractional lottery tickets as commanded by the processor 42. The display device 50 is preferably a video monitor for displaying at least alphanumeric characters to the customer and/or a cashier operating the POS terminal 40. Many types of input devices, printers and display devices are known to those skilled in the art, and need not be described in detail herein.

The storage device 44 stores a POS terminal program 52 for controlling the processor 42. The processor 42 performs instructions of the POS terminal program 52, and thereby operates in accordance with the present invention, and particularly in accordance with the methods described in detail herein. The POS terminal program 52 furthermore includes program elements that may be necessary, such as an operating system and “device drivers” for allowing the processor 42 to interface with computer peripheral devices, such as the input device 46, the printer 48 and the display device 50. Appropriate device drivers and other necessary program elements are known to those skilled in the art, and thus need not be described in detail herein.

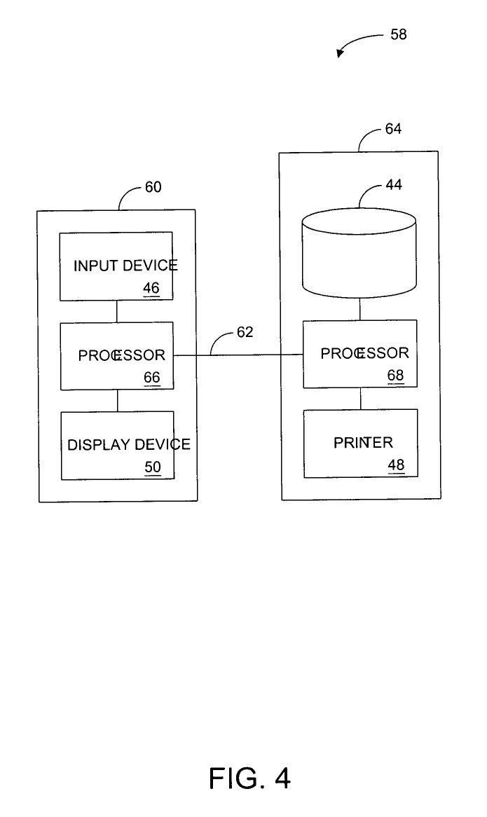

FIG. 4 illustrates an alternate embodiment of a POS terminal 58, which is descriptive of the POS terminals 14, 16, 18 and 20 of FIG. 1. A control device 60 is in communication via a communication medium 62 with a system 64 for printing fractional lottery tickets, receipts and/or coupons. The control device 60 comprises a processor 66 that is in communication with the input device 46 (FIG. 3) and the display device 50 (FIG. 3). The system 64 for printing comprises a processor 68 in communication with the storage device 44 (FIG. 3) and the printer 48 (FIG. 3). In this embodiment, the control device 60 may be a cash register, and the system 64 may be an electronic device for printing tickets in accordance with data received from the cash register. Other configurations of the POS terminal 40 will be understood by those skilled in the art.

The description that follows is arranged into the following sections: Creating Fractional Lottery Tickets, Acquiring Lottery Tickets, and Redeeming Portions of Lottery Tickets.

### Creating Fractional Lottery Tickets

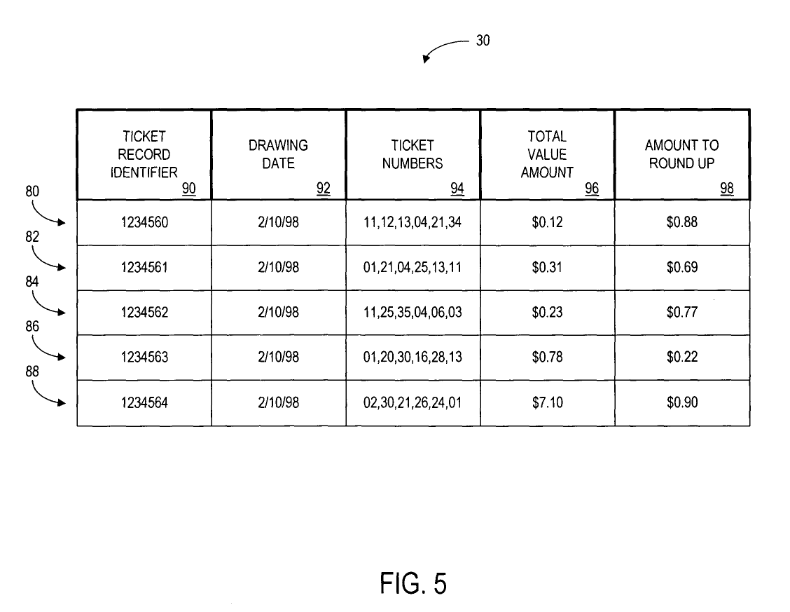

Referring to FIG. 5, the ticket record database 30 of FIG. 2 includes rows 80, 82, 84, 86 and 88, each of which represents an entry of the ticket record database 30. Each entry defines a set of ticket numbers that are included on one or more fractional lottery tickets. Thus, each entry defines one or more lottery tickets to be purchased. In particular, each entry includes (i) a ticket record identifier 90 that uniquely identifies the entry; (ii) a drawing date 92 that indicates when winning ticket numbers will be announced; (iii) ticket numbers 94; (iv) a total value amount 96, which is the sum of all values of the fractional lottery tickets which have the corresponding ticket numbers; and (v) an amount to round up 98, which is a minimal amount that, when added to the total value amount 96, yields a sum that is a whole-number multiple of the corresponding lottery ticket price.

The total value amount indicates for each entry how many lottery tickets having the same set of the corresponding ticket numbers should be purchased. In one embodiment, the number of lottery tickets to purchase is determined by the price of a lottery ticket. In particular, the total number of lottery tickets purchased for an entry may be the lowest integer number of tickets such that the total price of the purchased tickets is greater than the corresponding total value amount. For example, if the total value amount is $7.84 and the price of a lottery ticket is $1.00, then eight lottery tickets cost $8.00, which is greater than $7.84, yet seven lottery tickets cost $7.00, which is less than $7.84. Accordingly, the lowest number of lottery tickets that yields a total price greater than $7.84 is eight lottery tickets, so eight lottery tickets should be purchased. In another example, if the total value amount is $5.51 and the price of a lottery ticket is $2.00, then three lottery tickets cost $6.00, which is greater than $5.51, yet two lottery tickets cost $4.00, which is less than $5.51. Accordingly, the lowest number of lottery tickets that yields a total price greater than $5.51 is three lottery tickets, so three lottery tickets should be purchased.

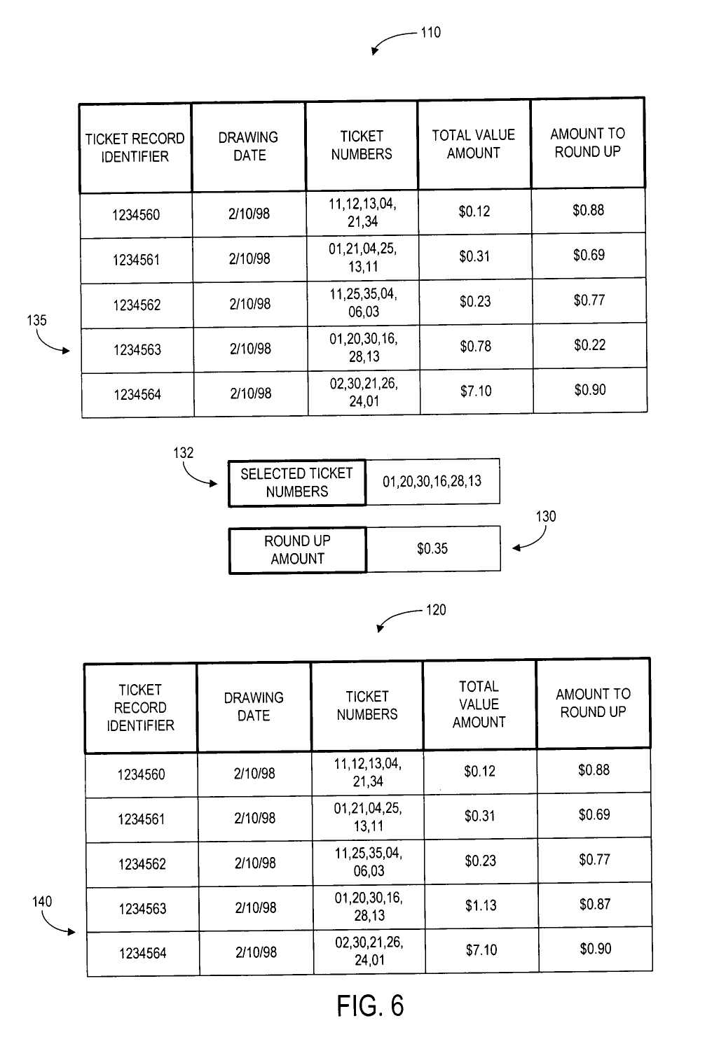

Referring to FIG. 6, exemplary data for the ticket record database 30 (FIGS. 2 and 5) are shown before and after a fractional lottery ticket has been issued. The table 110 represents the ticket record database 30 before a transaction represented by a round-up amount 130. The table 120 represents the ticket record database 30 after the transaction represented by the round-up amount 130. The round-up amount 130 has a value of $0.35, and corresponds to a transaction where a customer exchanges his change due ($0.35) for a fractional lottery ticket. The fractional lottery ticket defines a portion of a lottery ticket, and the portion is based on the monetary amount $0.35. Reference numeral 132 indicates a set of ticket numbers, and may be chosen by the customer or generated by a POS terminal.

As described above, each of the entries shown in the table 110 corresponds to a set of ticket numbers. The set of ticket numbers indicated by reference numeral 132 is the ticket numbers “01, 20, 30, 16, 28, 13”. The entry 135 of the table 110 also represents the ticket numbers “01, 20, 30, 16, 28, 13”. Accordingly, the entry 135 is selected, and the corresponding total value amount is increased by $0.35. An entry 140 of the table 120 represents the ticket numbers “01, 20, 30, 16, 28, 13” after the total value amount is increased by $0.35 (from $0.78 to $1.13).

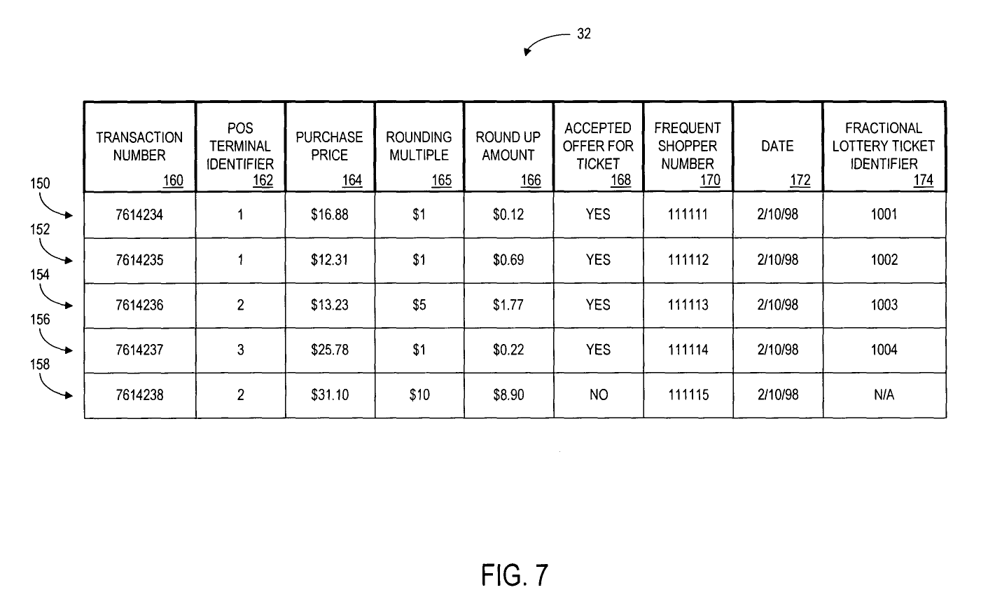

Referring to FIG. 7, the transaction database 32 of FIG. 2 includes rows 150, 152, 154, 156 and 158, each of which represents an entry of the transaction database 32. Each entry defines a transaction initiated by a POS terminal. In particular, each entry includes (i) a transaction number 160 that uniquely identifies the transaction; (ii) a POS terminal identifier 162 that uniquely identifies the POS terminal initiating the transaction; (iii) a purchase price 164; (iv) a rounding multiple 165 that is used to indicate an amount to which the purchase price is to be rounded; (v) a round-up amount 166 that is the monetary amount used to purchase the fractional lottery ticket; (vi) an indication of whether the offer for a fractional lottery ticket was accepted 168; (vii) a frequent shopper number 170 identifying a customer who has used a frequent shopper card for the transaction; (viii) a date 172 of the transaction; and (ix) a fractional lottery ticket identifier 174 that identifies a fractional lottery ticket provided in exchange for the round-up amount.

The round-up amount 166 is the monetary amount used to purchase the fractional lottery ticket. In some embodiments, the value of a fractional lottery ticket is equal to the round-up amount 166. For example, a customer may have $0.62 in change (the round-up amount) from a purchase, and use that change to acquire a fractional lottery ticket that defines a $0.62 portion of a lottery ticket. However, the value of the fractional lottery ticket need not be equal to the monetary amount used to purchase the fractional lottery ticket. In certain embodiments, the value of a fractional lottery ticket is based on a rounded-down (or rounded-up) monetary amount. For example, a customer may have $0.62 in change from a purchase, and use that change to acquire a fractional lottery ticket. The fractional lottery ticket may have a value of $0.60 ($0.62 rounded down to the nearest nickel). Of course, the monetary amount may be rounded down to other multiples, such as to the nearest dime, quarter or dollar, and that rounded amount would define the value, and thus a portion of a lottery ticket. The difference between the change due and the rounded-down amount upon which the fractional lottery ticket is based may be kept as a service fee by the seller of the fractional lottery ticket.

The value of a fractional lottery ticket may be based on the monetary amount in still further ways. For example, the value may be double the monetary amount. It may be advantageous to provide such a value if a customer buys a predetermined good or type of good, or if the customer uses a frequent shopper card. For example, if a customer has $0.62 in change and purchases a product of a particular manufacturer, the customer may receive a fractional lottery ticket having a value of $1.24 (double $0.62) in exchange for his change.

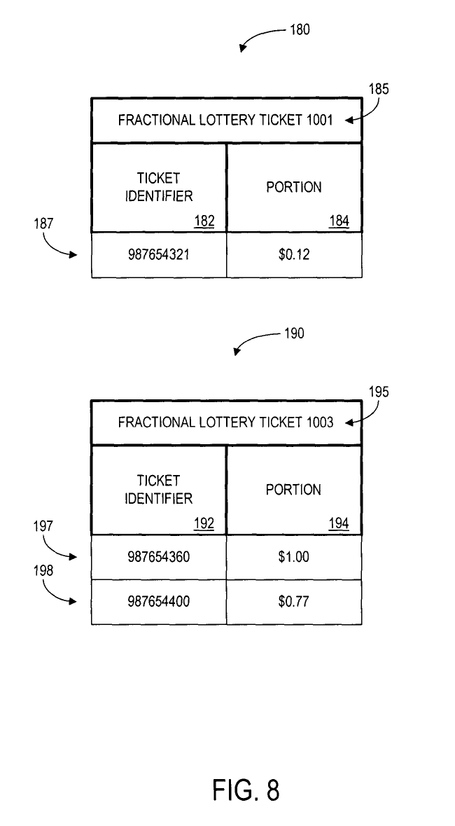

Referring to FIG. 8, tables 180 and 190 represent records of the fractional ticket database 34 (FIG. 2). Typically, the fractional ticket database 34 includes a plurality of records such as those represented by the table 180 and 190. Each record of the fractional ticket database 34 defines a fractional lottery ticket.

The record represented by the table 180 defines a fractional lottery ticket that is identified by an identifier 185 (the identifier “1001”). The table 180 includes an entry 187, which defines a portion of a lottery ticket that is included in the fractional lottery ticket “1001”. The entry 187 includes (i) a ticket identifier 182 that uniquely identifies the lottery ticket; and (ii) a portion 184 indicating a portion of the lottery ticket that is included in the fractional lottery ticket “1001”.

Similarly, the record represented by the table 190 defines a fractional lottery ticket that is identified by an identifier 195 (the identifier “1003”). The table 190 includes entries 197 and 198, which each include (i) a ticket identifier 192; and (ii) a portion 194. Since the fractional lottery ticket “1003” includes portions from more than one lottery ticket, the fractional lottery ticket “1003” may include portions which collectively exceed the maximum price of one lottery ticket. Accordingly, the value of the fractional lottery ticket “1003” may exceed the maximum price of one lottery ticket.

As described above, a fractional lottery ticket has a “value” that defines a portion of a lottery ticket, or portions of more than one lottery ticket. In certain embodiments, the ticket numbers of the fractional lottery ticket are not chosen by the customer, but are instead chosen automatically by the POS terminal or store controller 10 (FIG. 1). In such embodiments, ticket numbers are selected from the sets of ticket numbers of the ticket record database 30 (FIG. 2). The ticket numbers may be selected in several ways. For example, an entry of the ticket record database 30 may be selected at random, and thus the ticket numbers of the fractional lottery ticket are selected randomly.

Alternatively, an entry may be selected based on the value of the fractional lottery ticket and the respective amounts to round up of the entries. In one embodiment, an entry having an amount to round up at least as great as the value may be selected. Similarly, a set of entries that each have an amount to round up at least as great as the value may be determined. From this set, the entry that has a minimal amount to round up is selected. The description below further clarifies this method of selecting an entry from the ticket record database 30.

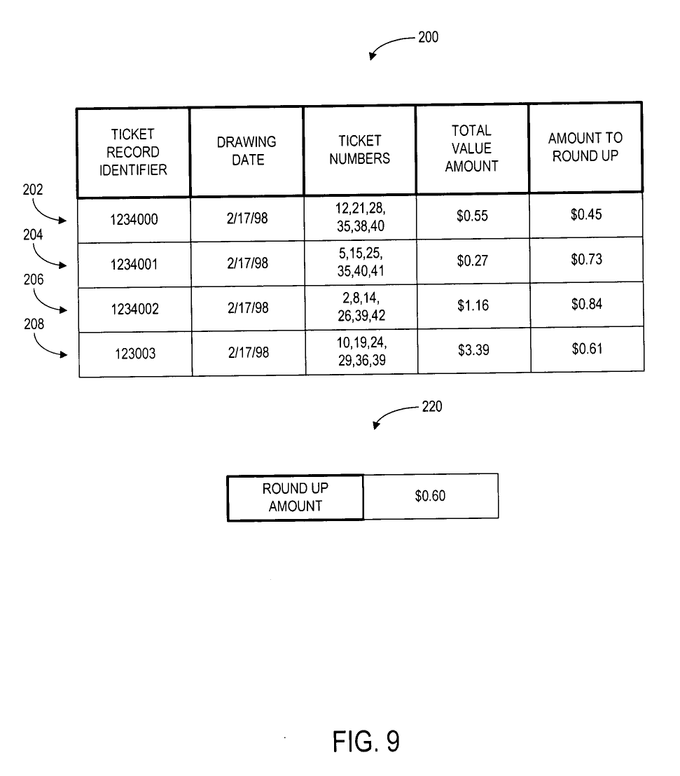

Referring to FIG. 9, a table 200 illustrates exemplary data for the ticket record database 30 (FIGS. 2 and 5). The table 200 includes entries 202, 204, 206 and 208. A round-up amount 220 of $0.60 corresponds to a transaction where a customer exchanges his change due ($0.60) for a fractional lottery ticket. The fractional lottery ticket has a value of $0.60. To select an entry of the ticket record database 30 to define the ticket numbers of the fractional lottery ticket, the store controller 10 determines a set of entries that each have an amount to round up of at least $0.60. This set includes the entries 204, 206 and 208. From this set, the lottery ticket which has a minimal amount to round up is selected. Of the entries 204, 206 and 208, the entry 208 has the minimal amount to round up ($0.61). Accordingly, the entry 208 is selected, the corresponding total value amount is increased by $0.60 (i.e. from $3.39 to $3.99), and the corresponding amount to round up is adjusted (i.e. to $0.01) to reflect the increased total value amount.

In other embodiments, the customer may select the ticket numbers himself at the time of the transaction, either manually or through ticket numbers stored on a card, such as a smart card or a frequent shopper card having a magnetic strip. Such an embodiment allows a customer to obtain a fractional lottery ticket having his favorite or “lucky” numbers. The ticket record database 30 is searched to determine if an entry already indicates the customer-selected ticket numbers. If so, then the total value amount is increased in accordance with the value of the fractional lottery ticket, and the amount to round up is adjusted to reflect the increased total value amount, as described above. If no entry indicates the customer-selected ticket numbers, a new entry is created in the ticket record database 30. The new entry includes (i) a unique ticket record identifier, (ii) an appropriate drawing date, (iii) the customer-selected ticket numbers, (iv) a total value amount equal to the value of the fractional lottery tickets, and (v) an appropriate amount to round up.

Once a fractional lottery ticket has been determined, the POS terminal prints for the customer a ticket indicative of the fractional lottery ticket, for example, on a receipt. The printed ticket serves as proof that the customer is entitled to the indicated portions of any prizes for the indicated ticket numbers. Such a printed ticket may include the corresponding (i) fractional lottery ticket identifier, (ii) ticket numbers, (iii) portion(s) of lottery ticket(s) included in the fractional lottery ticket, (iv) transaction identifier, and (v) an encrypted code based on any combination thereof. Such an encrypted code may be used to verify that the printed ticket is unaltered. Encryption techniques are described in “Applied Cryptography: Protocols, Algorithms and Source Code in C, Second Edition”, by Bruce Schneier, published 1996. Those skilled in the art will understand that the encrypted code will be determined by a cryptographic algorithm such that it would be almost impossible for a forger to generate a valid code, much less a code that indicates winning ticket numbers.

The printed ticket may also include contractual language, such as provisions assigning to the customer the right and title in and to the indicated portions of any prizes for the indicated ticket numbers. Still further matter such as the drawing date and an expiration date of the fractional lottery ticket may be included on the printed ticket, as will be understood by those skilled in the art. It may be further desirable to print a bar code that indicates any or all of the above information, thereby facilitating entry of the information using a bar code scanner.

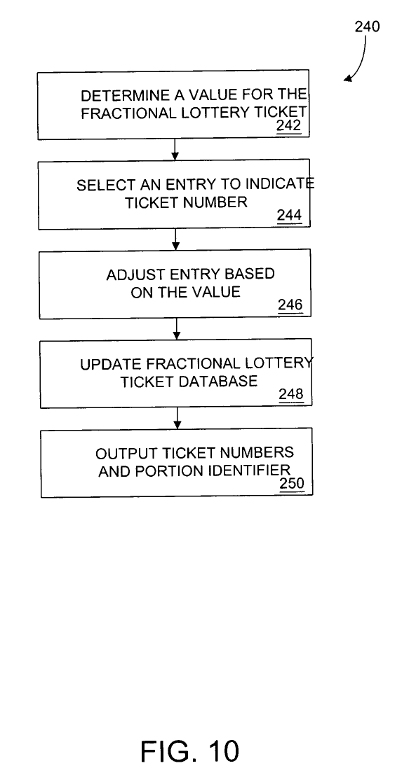

FIG. 10 illustrates a method 240 for creating fractional lottery tickets. In one embodiment, the method 240 is performed if a customer accepts an offer to exchange his spare change for a fractional lottery ticket. At step 242, a value for the fractional lottery ticket is determined. For example, a POS terminal may calculate an amount of change due and round this amount down to the nearest dime. The POS terminal transmits the rounded amount to the store controller, and the store controller thereby determines the value to be this rounded amount. The store controller in turn selects an entry (step 244) of the ticket record database 30, the entry indicating the ticket numbers for the fractional lottery ticket. As described above, the entry may be selected randomly, such as when the customer allows randomly-selected ticket numbers to be used on his fractional lottery ticket. Alternatively, the entry may be selected based on the value, as described above. If the fractional lottery ticket is to include customer-selected ticket numbers that are not represented in the ticket record database 30, then a new entry is created and selected.

The selected entry is adjusted based on the value (step 246). For example, the corresponding total value amount is increased by the value, and the corresponding amount to round up is adjusted to reflect the increased total value amount. At step 248, the fractional ticket database 34 (FIG. 2) is likewise adjusted to create a new record defining the fractional lottery ticket. The store controller then outputs ticket numbers and the value of the fractional lottery ticket (step 250). The store controller typically transmits the ticket numbers and the value to the POS terminal, and the POS terminal in turn prints a fractional lottery ticket based on thereon. The POS terminal may print on the fractional lottery ticket the ticket numbers and the value, as well as any other desirable information, such as a drawing date.

### Acquiring Lottery Tickets

As described above, each entry of the ticket record database 30 (FIG. 2) defines one or more lottery tickets to be purchased. The store controller 10 (FIG. 1) sends signals to the lottery server 12 (FIG. 1) to purchase lottery tickets. In particular, enough lottery tickets are purchased before the drawing date to assure that each fractional lottery ticket corresponds to portions of the lottery tickets.

Tickets may be purchased at predefined periods, such as at the end of each business day and/or as requested by an operator of the store controller 10. It may further be desirable to purchase all required lottery tickets at a predefined time before the drawing, such as twelve hours before the drawing. In such an embodiment, additional fractional lottery tickets for that drawing may not be issued after such a predetermined time. However, customers would still be able to purchase fractional lottery tickets for later drawings.

In another embodiment, lottery tickets for each entry in the ticket record database 30 (FIG. 2) may be purchased when the amount to round up of the entry is below a predetermined value. For example, each time the amount to round up of an entry is below $0.02, and the number of already-purchased lottery tickets (if any) corresponding to that entry is insufficient with respect to the total value amount, one or more additional lottery tickets are purchased.

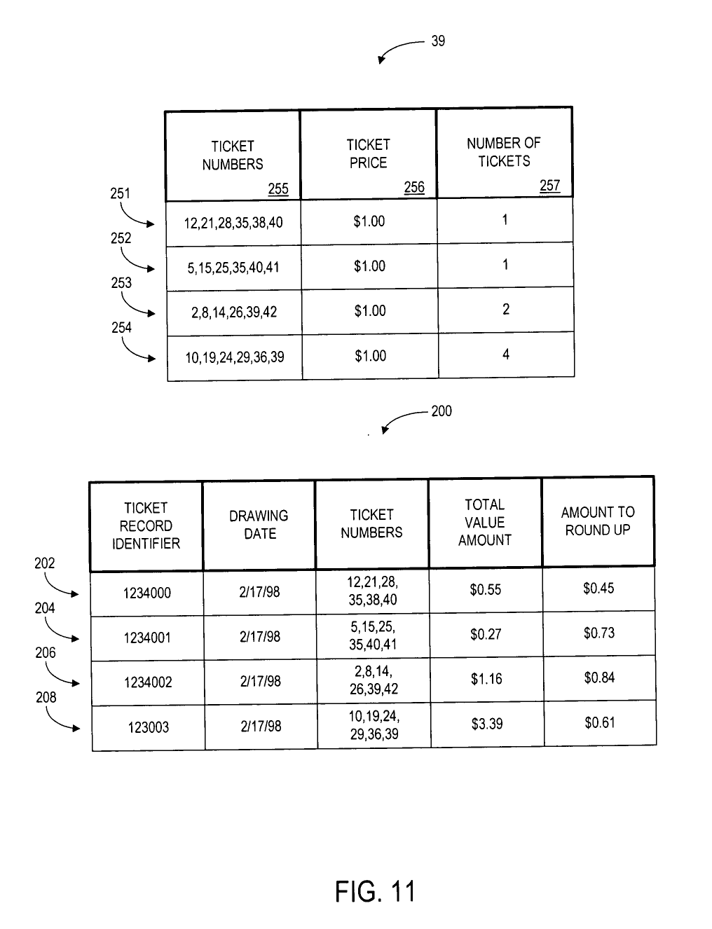

Referring to FIG. 11, the ticket supply database 39 (FIG. 2) includes entries 251, 252, 253 and 254, each of which defines a number of lottery tickets having the same set of ticket numbers. Each entry includes (i) ticket numbers 255 (ii) a ticket price 256, and (iii) a number of lottery tickets 257 that have been purchased. As illustrated by FIG. 9, each entry of the ticket supply database 39 corresponds to an entry of the ticket record database 30. Further, the number of tickets for each entry of the ticket supply database 39 defines a number of purchased lottery tickets that is sufficient with respect to the total value amount of the corresponding entry of the ticket record database 30. For example, the entry 254 defines four purchased lottery tickets, each at a price of $1.00. Thus, there are enough tickets with the ticket numbers “10, 19, 24, 29, 36, 39” for a total value amount of up to $4.00 (4*$1.00=$4.00). Since the corresponding entry 208 indicates a total value amount of $3.39, the four tickets are sufficient.

### Redeeming Portions of Lottery Tickets

The business or other entity acquiring and maintaining the supply of lottery tickets may check each to determine whether any are winning tickets. If so, the business preferably redeems the winning tickets for prizes as soon as practical, so that the prizes may be used to pay those customers that have corresponding fractional lottery tickets. Winning ticket numbers may be entered manually into the store controller 10 (FIG. 1) when available. Ideally, the store controller 10 will receive from the lottery server 12 (FIG. 1) the winning ticket numbers for each drawing date. The store controller can store these winning ticket numbers in the winning lottery ticket database 36 (FIG. 2).

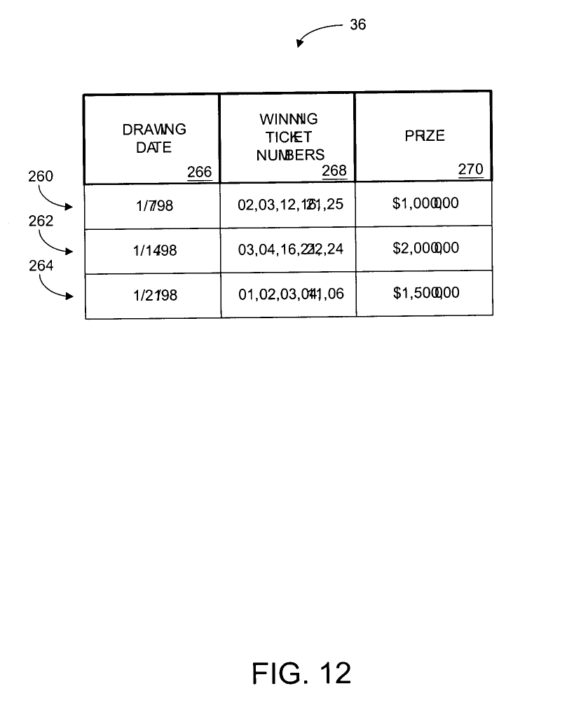

Referring to FIG. 12, the winning lottery ticket database 36 includes entries 260, 262 and 264, each defining winning ticket numbers for a drawing date. Each entry includes (i) a corresponding drawing date 266, (ii) winning ticket numbers 268, and (iii) a prize 270. The winning lottery ticket database 36 should include entries for all drawing dates corresponding to valid and redeemable fractional lottery tickets. For example, if fractional lottery tickets may be redeemed up to one year after the corresponding drawing date, then the entries for each drawing date of at least the past year should be stored. The prize 270 may be, for example, the prize won upon matching all winning ticket numbers. More prizes may be specified for each entry. For example, a prize for matching only five of six winning ticket numbers may be specified for each entry as well.

When winning ticket numbers for a drawing date are received by the store controller 10 (FIG. 1), the store controller 10 may simply store them in the winning lottery ticket database 36, where they are accessed when fractional lottery tickets are redeemed by customers. However, the store controller 10 may also determine which fractional lottery tickets include portions of a winning lottery ticket. Then the corresponding records of the fractional ticket database 34 (FIG. 2) may be modified to indicate that the fractional lottery tickets include portions of winning lottery tickets. In addition, if those fractional lottery tickets were purchased using frequent shopper cards, then the corresponding customer may be notified.

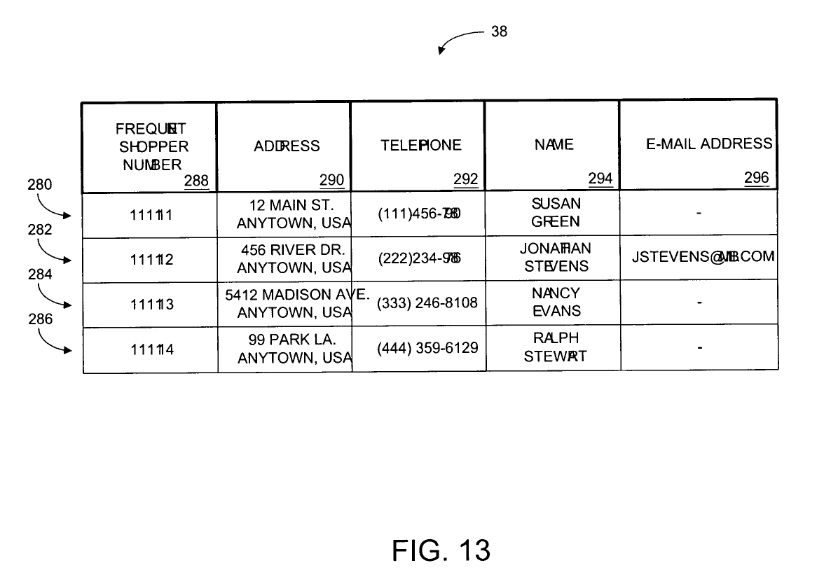

Referring to FIG. 13, the frequent shopper database 38 includes entries 280, 282, 284 and 286, each defining a frequent shopper (a customer who has used a frequent shopper card for the transaction). In particular, each entry includes (i) a frequent shopper number 288 for uniquely identifying the frequent shopper; (ii) an address 290 of the frequent shopper; (iii) a telephone number 292 of the frequent shopper; (iv) a name 294 of the frequent shopper; and (v) an email address 296 of the frequent shopper. With such stored information, frequent shoppers may be notified by mail, telephone call, email or other forms of notification as desired. In addition, frequent shoppers may be notified by the POS terminal when they next use their frequent shopper card. Providing frequent shopper with the additional benefit of notification is advantageous because it may prompt customers to become frequent shoppers. Consequently, these customers are more likely to continue frequenting the corresponding business.

As further incentive to become a frequent shopper, it may be desirable to only provide frequent shoppers with the opportunity to purchase fractional lottery tickets. For example, an offer for a fractional lottery ticket may be provided only during transactions in which a frequent shopper card is used.

To redeem a fractional lottery ticket, a customer preferably provides the printed ticket to show that he is entitled to the indicated share of the prize. The printed ticket is verified to assure that it is valid and unaltered. For example, if the printed ticket is valid, the fractional lottery ticket identifier inscribed on the printed ticket indicates a record in the fractional ticket database 34 (FIG. 2). That record should in turn indicate corresponding information on the printed ticket. In addition, the encrypted code can be verified.

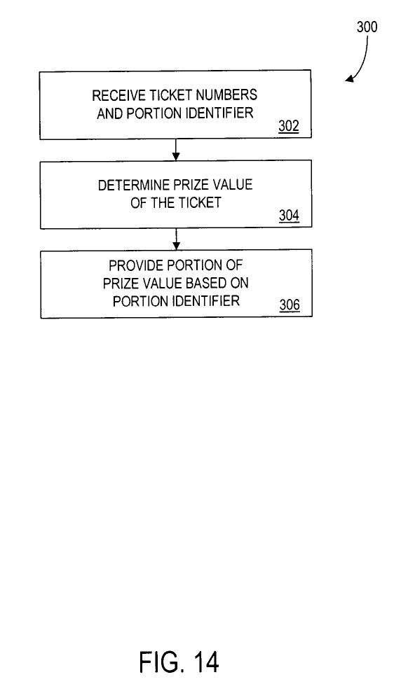

Referring to FIG. 14, a method 300 for redeeming a fractional lottery ticket initiates by receiving (i) a ticket numbers, and (ii) a portion identifier that identifies an allocated portion of the lottery ticket (step 302). Such identifiers may be received by manually entering one or more identifiers into a POS terminal, from which the identifiers are transmitted to the store controller 10 (FIG. 1). Alternatively, a bar code scanner of the POS terminal may read a bar code on the printed ticket, and transmit the bar code to the store controller 10. The entered identifier or bar code may be indicative of the fractional lottery ticket identifier, which may be used to retrieve a corresponding ticket identifier and portion identifier from the fractional ticket database 34 (FIG. 2). The store controller thus receives the ticket identifier and portion identifier.

Once the identifiers are received, thereby identifying one or more lottery tickets and allocated portions thereof, a prize value of the lottery tickets is determined (step 304). As discussed above, the prize value may be determined by comparing ticket numbers of a lottery ticket with winning ticket numbers stored in the winning lottery ticket database 36 (FIG. 2). As also described above, the portion of the prize that is to be provided to the customer is determined by the allocated portion of the lottery ticket. This portion of the prize is provided to the customer (step 306), typically by providing cash from a cash register or by writing or printing a check made out to the customer.

A winning lottery ticket that has been purchased may have an unallocated portion greater than zero. Such a winning lottery ticket will have an associated portion of the prize value that is not to be paid to customers. This portion of the prize is instead retained by the business, and may be used to finance various customer incentives. For example, a portion of retained prize value may be provided back to customers in the form of fractional lottery tickets (e.g., $0.05 of change buys a $0.50 fractional lottery ticket).

The business may retain further winnings by providing winning tickets with portions of certain prize values. For example, customers may only be provided with shares of “jackpot” prizes (e.g. matching all six winning ticket numbers). Any other prizes are retained by the business. Of course, such restrictions would typically be explained to the customers through advertising and printed information on the fractional lottery ticket.

Although the present invention has been described with respect to a preferred embodiment thereof, those skilled in the art will note that various substitutions may be made to those embodiments described herein without departing from the spirit and scope of the present invention. For example, the present invention is applicable to many types of games besides lotteries in which prizes are awarded. In addition, in some embodiments the data stored on the store controller may instead be stored among the POS terminals. Similarly, some of the functions performed by the store controller may be performed by the POS terminal, and vice versa.

What is claimed is:

1. A method for facilitating the purchase of fractional lottery tickets using a point-of-sale terminal, comprising:
determining a monetary value;
selecting a ticket record that includes a set of ticket numbers;
purchasing at least one lottery ticket based on the monetary value and the set of ticket numbers after the step of selecting; and
outputting the ticket numbers and a fractional lottery ticket value that is based on the monetary value.

2. The method of claim 1, in which the step of determining a monetary value comprises:
determining a monetary value based on an amount of change due for a purchase.

3. The method of claim 1, in which the step of selecting comprises:
creating the ticket record.

4. The method of claim 1, in which the step of selecting comprises:
selecting a ticket record randomly.

5. The method of claim 1, further comprising:
receiving a signal indicating selected ticket numbers.

6. The method of claim 5, in which the step of selecting comprises:
searching a plurality of ticket records to select a ticket record that indicates the selected ticket numbers.

7. The method of claim 1, further comprising:
increasing a total value amount of the selected ticket record in accordance with the fractional lottery ticket value.

8. The method of claim 7, further comprising:
adjusting an amount to round up based on the increased total value amount.

9. The method of claim 1, in which the step of selecting comprises:
selecting a ticket record having an amount to round up at least as great as the fractional lottery ticket value.

10. The method of claim 1, in which the step of selecting comprises:
determining a set of ticket records that each have an amount to round up at least as great as the fractional lottery ticket value; and
selecting a ticket record from the set of ticket records which has a minimal amount to round up.

11. A method for facilitating the purchase of fractional lottery tickets using a point-of-sale terminal, comprising:
determining an amount of change due for a purchase;
determining a monetary value based on the amount of change due;
selecting a ticket record that includes a set of ticket numbers;
purchasing at least one lottery ticket based on the value and the set of ticket numbers after the step of selecting; and
outputting the ticket numbers and a fractional lottery ticket value that is based on the monetary value.

12. The method of claim 11, in which the step of determining a monetary value comprises:
rounding the amount of change due to a predetermined multiple, thereby generating a rounded change amount; and
setting the monetary value equal to the rounded change amount.

13. The method of claim 12, in which the step of rounding the amount of change due comprises:
rounding down the amount of change due to a predetermined multiple, thereby generating a rounded-down change amount.

14. The method of claim 11, further comprising:
outputting an offer to exchange a fractional lottery ticket for change due.

15. A method for facilitating the purchase of fractional lottery tickets using a point-of-sale terminal, comprising:
determining a monetary value;
selecting a ticket record that includes a set of ticket numbers;
purchasing at least one lottery ticket based on the value and the set of ticket numbers after the step of selecting; and
outputting the ticket numbers and a fractional lottery ticket value that is based on the monetary value;
determining a prize value of the at least one lottery ticket; and
providing a portion of the prize value based on the fractional lottery ticket value.

16. A method for facilitating the purchase of fractional lottery tickets using a point-of-sale terminal, comprising:
determining a total value amount corresponding to a set of ticket numbers; and
acquiring at least one lottery ticket having the set of ticket numbers based on the total value amount.

17. The method of claim 16, in which the step of acquiring is performed at predefined periods.

18. The method of claim 16, in which the step of acquiring is performed at a predefined time before a drawing.

19. The method of claim 16, further comprising:
determining an amount to round up based on the total value amount; and in which the step of acquiring is performed when the amount to round up is below a predetermined value.

20. An apparatus for facilitating the purchase of fractional lottery tickets using a point-of-sale terminal, comprising:
a storage device; and
a processor connected to the storage device,
the storage device storing a program for controlling the processor; and
the processor operative with the program to:
determine a monetary value;
select a ticket record that includes a set of ticket numbers;
purchase at least one lottery ticket based on the monetary value and the set of ticket numbers after the step of selecting; and
output the ticket numbers and a fractional lottery ticket value that is based on the monetary value.

21. A computer readable medium encoded with processing instructions for implementing a method for facilitating the purchase of fractional lottery tickets using a point-of-sale terminal, the method comprising:
determining a monetary value;
selecting a ticket record that includes a set of ticket numbers;
purchasing at least one lottery ticket based on the monetary value and the set of ticket numbers after the step of selecting; and
outputting the ticket numbers and a fractional lottery ticket value that is based on the monetary value.

22. An apparatus for facilitating the purchase of fractional lottery tickets using a point-of-sale terminal, comprising:
a storage device; and
a processor connected to the storage device,
the storage device storing a program for controlling the processor; and
the processor operative with the program to:
determine an amount of change due for a purchase;
determine a monetary value based on the amount of change due;
select a ticket record that includes a set of ticket numbers;
purchase at least one lottery ticket based on the value and the set of ticket numbers after the step of selecting; and
output the ticket numbers and a fractional lottery ticket value that is based on the monetary value.

23. A computer readable medium encoded with processing instructions for implementing a method for facilitating the purchase of fractional lottery tickets using a point-of-sale terminal, the method comprising:
determining an amount of change due for a purchase;
determining a monetary value based on the amount of change due;
selecting a ticket record that includes a set of ticket numbers;
purchasing at least one lottery ticket based on the value and the set of ticket numbers after the step of selecting; and
outputting the ticket numbers and a fractional lottery ticket value that is based on the monetary value.

24. An apparatus for facilitating the purchase of fractional lottery tickets using a point-of-sale terminal, comprising:
a storage device; and
a processor connected to the storage device,
the storage device storing a program for controlling the processor; and
the processor operative with the program to:
determine a monetary value;
select a ticket record that includes a set of ticket numbers;
purchase at least one lottery ticket based on the value and the set of ticket numbers after the step of selecting; and
output the ticket numbers and a fractional lottery ticket value that is based on the monetary value;
determine a prize value of the at least one lottery ticket; and
provide a portion of the prize value based on the fractional lottery ticket value.

25. A computer readable medium encoded with processing instructions for implementing a method for facilitating the purchase of fractional lottery tickets using a point-of-sale terminal, the method comprising:
determining a monetary value;
selecting a ticket record that includes a set of ticket numbers;
purchasing at least one lottery ticket based on the value and the set of ticket numbers after the step of selecting; and
outputting the ticket numbers and a fractional lottery ticket value that is based on the monetary value;
determining a prize value of the at least one lottery ticket; and
providing a portion of the prize value based on the fractional lottery ticket value.

26. An apparatus for facilitating the purchase of fractional lottery tickets using a point-of-sale terminal, comprising:
a storage device; and
a processor connected to the storage device,
the storage device storing a program for controlling the processor; and
the processor operative with the program to:
determine a total value amount corresponding to a set of ticket numbers; and
acquire at least one lottery ticket having the set of ticket numbers based on the total value amount.

27. A computer readable medium encoded with processing instructions for implementing a method for facilitating the purchase of fractional lottery tickets using a point-of-sale terminal, comprising:
determining a total value amount corresponding to a set of ticket numbers; and
acquiring at least one lottery ticket having the set of ticket numbers based on the total value amount.
